(19) United States
(12) Patent Application Publication
(10) Pub. No.: US 2009/0093223 A1
(43) Pub. Date: Apr. 9, 2009

(54) METHODS AND APPARATUS FOR REDUCING RADIATED FIELD FEEDBACK IN RADIO FREQUENCY TRANSMITTERS

(75) Inventor: Earl W. McCune, JR., Santa Clara, CA (US)

Correspondence Address: PATENT LAW PROFESSIONALS, P.O. BOX 612407, SAN JOSE, CA, 95161, US

(73) Assignee: Matsushita Electric Industrial Co., Ltd.

(21) Appl. No.: 11/867,945

(22) Filed: Oct. 5, 2007

(51) Int. Cl. H04B 1/04

(52) U.S. Cl. 455/126

(57) ABSTRACT

Methods and apparatus for reducing radiated field feedback in radio frequency (RF) transmitters. An exemplary RF transmitter includes a power amplifier (PA) and a low-field oscillator (LFO) that are co-located, either on a common module or integrated in the same integrated circuit chip. By using an LFO for the transmitter's local oscillator, radiated field feedback from the PA to the LFO is substantially reduced. In addition to, or instead of using an LFO to reduce radiated field feedback, the LFO or a voltage controlled oscillator (VCO) may be configured to operate at either a harmonic or a non-integer multiple of the transmitter's output signal frequency. Using an LFO or VCO and/or operating the oscillator at a harmonic or a non-integer multiple of the radio system output signal frequency reduces the degree by which electromagnetic fields generated by the radio system's PA and antenna interfere with electromagnetic fields generated by the LFO or VCO, thereby allowing the LFO or VCO to be co-located with or integrated in the same integrated circuit chip as the radio system's PA.

### FIELD OF THE INVENTION

The present invention relates to wireless communications. More specifically, the present invention relates to methods and apparatus for reducing radiated field feedback in radio frequency (RF) transmitters.

### BACKGROUND OF THE INVENTION

To satisfy consumer demand for smaller and more power-efficient wireless communications devices, radio engineers continue to seek new ways of miniaturizing the radio systems used in such devices. The availability of integrated circuit technology has contributed significantly to this miniaturization effort. For example, most all electrical components of state-of-the art radio systems used in cellular communications applications can now be implemented on only a few integrated circuit chips. These integrated solutions allow the manufacture of small, lightweight and power-efficient wireless communications devices. Even with these advances, radio engineers continue to seek new ways of reducing the size of radio systems even further, including ways of reducing the number of integrated circuit chips needed to implement the radio system. As explained below, these efforts are presented with various challenges and obstacles relating to the co-location or co-integration of certain radio system elements.

FIG. 1 is a block diagram of an RF transmitter 100 of a radio system commonly found in a modern wireless communications device, such as a cellular handset, for example. The RF transmitter 100 comprises a digital baseband integrated circuit (BB IC) 102 that includes a baseband processor 104; a mixed-signal radio frequency (RF) circuit 106 (often referred to in the art as an “RFIC”) that includes an upconverter 108 and a voltage controlled oscillator (VCO) 110; a power amplifier (PA) module 112 that includes a PA 114; and an antenna 116.

The PA module 112 is usually comprised of a printed circuit board (PCB) onto which the PA 114 and other circuit elements are mounted. The PA 114, in particular, is either formed from discrete devices mounted on the PCB, or is formed in an IC chip mounted on the PCB. In either case, the primary function of the PA 114 is to generate large electromagnetic fields needed for the radio system's antenna 116 to transmit signals to a remote basestation. The required strength of these electromagnetic fields is particularly high in radio systems that are employed in cellular communications applications, due to the large distances separating the handsets from the basestations. The large, intentionally radiated fields undesirably interfere with the inductive fields generated by the VCO 110, if the VCO 110 is co-located with the PA 114. This “radiated field feedback” phenomenon, which is conceptually illustrated in FIG. 2, is highly undesirable since it adversely affects the intended operating frequency of the VCO 110, contributes to signal distortion at the output of the PA 114, and can even render the VCO 110 unstable or inoperable.

To avoid the problems caused by radiated field feedback, prior art approaches are careful to physically separate the VCO 110 from the PA 114. They do this by designing and manufacturing the radio system so that the VCO 110 is neither formed on the same IC as the PA 114 nor co-located on the same module as the PA 114.

In an effort to provide as fully an integrated radio system as possible, while at the same time respecting the need to avoid radiated field feedback from the PA 114 to the VCO 110, the VCO 110 is usually integrated on the RFIC 106 while the PA 114 is maintained on the separate PA module 112. Unfortunately, integrating the VCO 110 on the RFIC 106 seriously comprises the manufacturing yields of the RFIC 106. In general, mixing analog and digital circuitry on the same IC results in low production yields. Analog circuitry is much more sensitive to processing variations than is digital circuitry and, therefore, is more prone to process-related failures. While the RFIC 106 typically includes analog circuitry even in the absence of the VCO 110, addition of the VCO 110 exacerbates the yield problems, primarily because the VCO 110 has large spiraled inductors that consume a large area of the RFIC 106. This large area of occupation increases the probability of yield losses. Additional chip area is also required to form buffer zones around the spiraled inductors. These buffer zones are needed to shield the VCO's inductive field from electrical signals generated by other circuit components on the RFIC 106. Unfortunately, the buffer zones substantially reduce the available chip area for other electrical components on the RFIC 106.

Given the foregoing problems and limitations of the prior art, it would be desirable to have radio systems that avoid the problems caused by radiated field feedback, and which also avoid the manufacturing yield problems that plague prior art radio system integration approaches.

### BRIEF SUMMARY OF THE INVENTION

Methods and apparatus for reducing radiated field feedback in radio frequency (RF) transmitters are disclosed. An exemplary radio transmitter includes a baseband processor, an upconverter, and an RF module containing both a power amplifier (PA) and a co-located low-field oscillator (LFO). By using an LFO for the transmitter's local oscillator, rather than a conventional voltage controlled oscillator (VCO) constructed from coils or spiraled inductors, radiated field feedback from the PA to the LFO is substantially avoided.

According to another aspect of the invention, in addition to, or instead of using an LFO to reduce radiated field feedback, an LFO or VCO of a radio transmitter is configured to operate at a harmonic of the system output signal frequency, i.e., at a harmonic of the frequency of the RF signal generated and radiated by the radio system's PA and antenna. A frequency divider circuit is included to divide the frequency of the signal from the LFO or VCO down to the desired output signal frequency. Operating the LFO or VCO at a harmonic reduces the degree by which electromagnetic fields generated by the PA and antenna interfere with electromagnetic fields generated by the LFO or VCO. In other words, radiated field feedback between the PA and the LFO or VCO is substantially avoided by operating the LFO or VCO at a harmonic of the system output frequency. Radiated field feedback can also be reduced by configuring the LFO or VCO to operate at a frequency that is a non-integer multiple of the fundamental frequency (i.e., not at a harmonic of the fundamental frequency), and using a fractional (i.e., non-integer) frequency divider circuit to divide the frequency of the signal down to the desired PA output signal frequency.

Using an LFO and/or operating the LFO or VCO at a different frequency than the PA output frequency provides a number of advantages over prior art approaches. Higher levels of integration can be achieved since the oscillator circuitry, which has been traditionally formed on a separate mixed-signal RFIC, can be formed on the same module or integrated circuit chip as the radio system's PA. By moving digital circuitry traditionally formed on the separate mixed-signal RFIC to the all-digital baseband integrated circuit, the need for a separate and dedicated RFIC can be eliminated and, as a consequence, the overall chip count needed to implement the radio system is reduced. Moreover, production costs relating to poor yields caused by the co-integration of analog oscillator circuitry (such as the oscillator circuitry) with digital circuitry on a separate mixed-signal RFIC are reduced.

Further aspects of the invention are described and claimed below, and a further understanding of the nature and advantages of the invention may be realized by reference to the remaining portions of the specification and the attached drawings.

### BRIEF DESCRIPTION OF THE DRAWINGS

FIG. 1 is a block diagram of an RF transmitter of a radio system commonly found in a modern wireless communications device;

FIG. 2 is a diagram illustrating how the electromagnetic field generated by a prior art radio system's PA and antenna is undesirably fed back to the radio system's VCO when the PA and VCO are co-located;

FIG. 3 is a block diagram of an RF transmitter, according to an embodiment of the present invention;

FIG. 4 is a block diagram of an RF transmitter, according to another embodiment of the present invention;

FIG. 5 is a drawing of an LFO that may be used to implement the LFOs in the RF transmitters in FIGS. 3 and 4, as well as the LFOs used in the other RF transmitters of the present invention;

FIG. 6 is a drawing of another type of LFO that may be used to implement the LFOs in the RF transmitters in FIGS. 3 and 4, as well as the LFOs used in the other RF transmitters of the present invention;

FIG. 7 is a block diagram of a polar transmitter having a co-located LFO and PA, according to an embodiment of the present invention;

FIG. 8 is a block diagram of an RF transmitter having an LFO or VCO that is co-located with the transmitter's PA and which is configured to operate at a harmonic of the output frequency of the RF transmitter, according to an embodiment of the present invention;

FIG. 9 is a block diagram of a polar transmitter having an LFO or VCO that is co-located with the transmitter's PA and which is configured to operate at a harmonic of the output frequency of the polar transmitter, according to an embodiment of the present invention;

FIG. 10 is a block diagram of an RF transmitter having an LFO or VCO that is co-located with the transmitter's PA and which is configured to operate at a non-integer multiple of the output frequency of the RF transmitter, according to an embodiment of the present invention;

FIG. 11 is a block diagram of a polar transmitter having an LFO or VCO that is co-located with the transmitter's PA and which is configured to operate at a non-integer multiple of the output frequency of the polar transmitter, according to an embodiment of the present invention; and

FIG. 12 is a graph comparing the injection lock susceptibilities of RF transmitters having a co-located VCO and PA (as in the prior art), having a co-located LFO and PA, and having a co-located LFO and PA in which the LFO is configured to operate at the second harmonic of the PA output frequency.

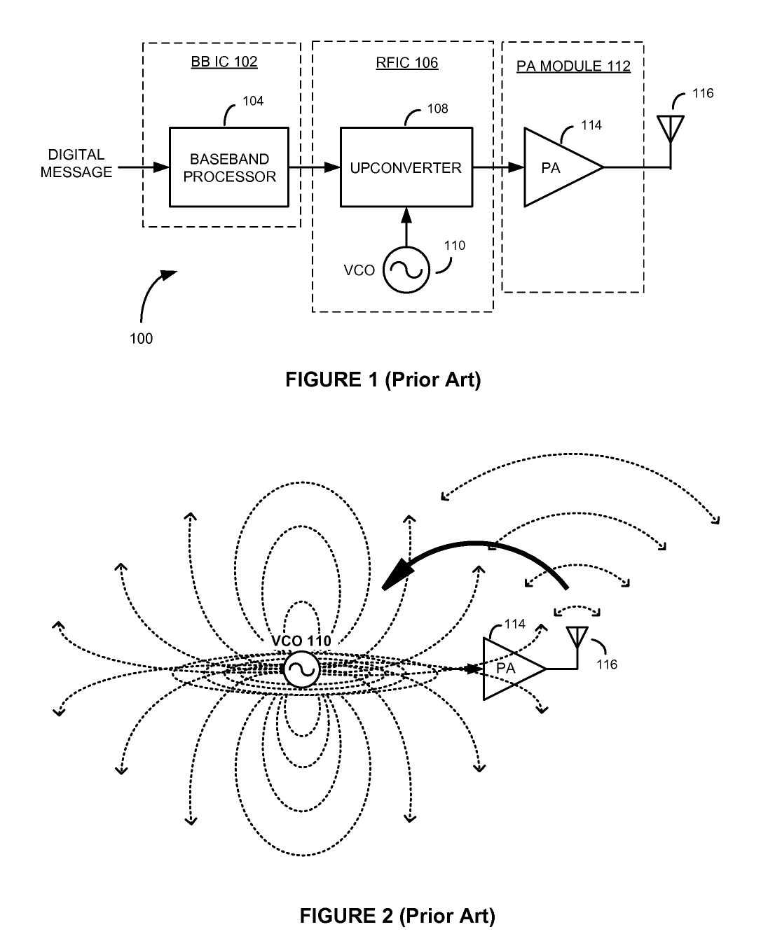

### DETAILED DESCRIPTION

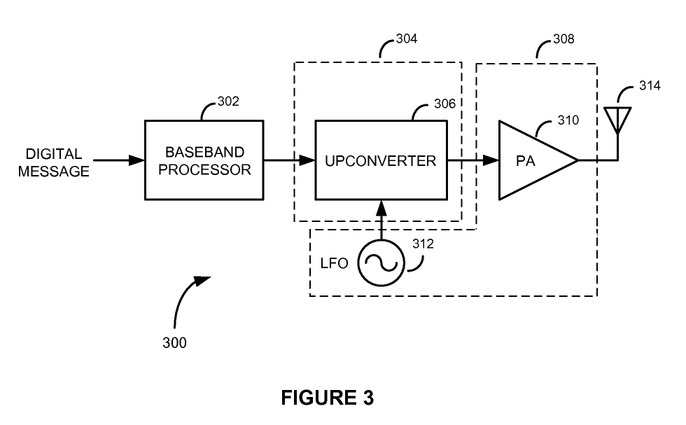

FIG. 3 is a block diagram of a radio frequency (RF) transmitter 300, according to an embodiment of the present invention. The RF transmitter 300 comprises a baseband processor 302, an RF integrated circuit (RFIC) 304 having an upconverter 306, a power amplifier (PA) module 308 having a PA 310 that is co-located with a low-field oscillator (LFO) 312, and an antenna 314. The baseband processor 302 is configured to receive a digital message and modulate the digital message according to any one of a number of baseband modulation schemes (e.g., Gaussian Minimum Shift Keying (GMSK), quadrature or 3π/8 8-phase shift keying (8-PSK), or some other modulation scheme), thereby generating digital baseband signals. A digital-to-analog converter (DAC), which may be configured within either the baseband processor 302 or the RFIC 304, converts the baseband signals to analog signals. These analog signals are then upconverted to RF by the upconverter 306, according to a carrier frequency provided by the LFO 312. Finally, the PA 310 amplifies the upconverted signals and couples the amplified result to the antenna 314, which radiates the amplified RF signals to a remote receiver (e.g., a cellular basestation receiver).

The PA 310 of the PA module 308, as well as the PA used in other embodiments of the invention described below, may be silicon-based or may be manufactured from a compound semiconductor such as, for example, gallium-arsenide (GaAs). The LFO 312 may also be either silicon-based or compound-semiconductor-based. If made from the same type of semiconductor as the PA 310, the LFO 312 and PA 310 can both be formed in the same integrated circuit. If made from different types of semiconductors, the LFO 312 and PA 310 are still co-located. For example, according to an exemplary embodiment of the invention, the LFO 312 is included within a silicon-based IC mounted on the module 308, and the PA 310 comprises a compound semiconductor based IC co-located with the LFO on the PA module 308. The IC containing the LFO 312 and the IC containing the PA 310 are mounted on the module 308 and are co-located very close to one another (e.g., less than a centimeter). The ability to co-locate the LFO 312 and the PA 310 is permissible since the LFO 312 is substantially less susceptible to radiated field feedback than a conventional VCO.

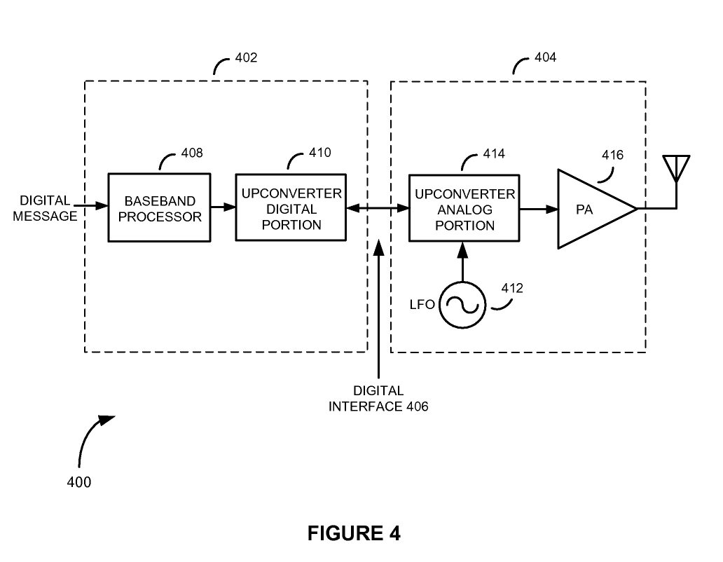

The RF transmitter 300 in FIG. 3 is comprised of three main elements: a baseband processor 302, an RFIC 304 and a PA module 308. FIG. 4 is a drawing of an RF transmitter 400, according to another embodiment of the invention. The RF transmitter 400 in FIG. 4 is comprised of two main elements: an all digital baseband integrated circuit (BB IC) 402 and a substantially all-analog RF module 404, which are separated by a digital interface 406. Unlike the RF transmitter 300 in FIG. 3, the RF transmitter 400 in FIG. 4 does not include or require a separate RFIC.

The BB IC 402 of the RF transmitter 400 includes a baseband processor 408 and the digital portion 410 of the transmitter's upconverter. The RF module 404 includes an LFO 412, the analog portion 414 of the transmitter's upconverter, and a PA 416. The all-digital BB IC 402 is formed from a digital semiconductor manufacturing processes such as, for example, the widely used complementary metal-oxide-semiconductor (CMOS) logic process.

The components on the RF module 404 may comprise devices formed from different types of semiconductor manufacturing processes (e.g., silicon-based processes or compound-semiconductor-based processes) or from the same semiconductor manufacturing process. If formed using the same semiconductor manufacturing process, the LFO 412, analog portion 414 of the transmitter's upconverter, and a PA 416 may all be formed in the same integrated circuit. If formed from different types of semiconductor manufacturing processes, the LFO 412 and PA 416 are still co-located on the RF module 404. For example, according to an exemplary embodiment of the invention, the LFO 412 and the analog portion 414 of the transmitter's upconverter comprise an integrated circuit formed from a silicon-based manufacturing process, and the PA 416 comprises a separate IC formed from a compound-semiconductor-based manufacturing process. The IC containing the LFO 412 and the analog portion 414 of the transmitter's upconverter is co-located with the IC containing the PA 416 (e.g., within one centimeter of one another) on the RF module 404.

The LFOs used in the RF transmitters 300 and 400 in FIGS. 3 and 4 above, and the LFOs used in other embodiments of the present invention, comprise oscillators that are inherently less susceptible to radiated field feedback from the PA than conventional VCOs which employ coils or spiraled inductors or which generate relatively large electromagnetic fields. This quality of being less susceptible to radiated field feedback renders the RF transmitters of the present invention particularly well suited for use in cellular handsets configured for operation in cellular communications networks, although the inventions described herein are not limited to only those types of applications, as will be readily appreciated by those of ordinary skill in the art.

To distinguish the LFOs used in the various embodiments of the present invention from prior art VCOs that employ coils or spiraled inductors or which generate large electromagnetic fields, the term “VCO” is used herein to refer to the latter. The term “LFO” (which may also be voltage controlled, despite the name difference) is used to refer to oscillator types that are inductor-less and coil-less and which generate comparatively lower fields. The low-field attribute of the LFO allows the LFO to be either co-located on the same module as the PA or formed in the same integrated circuit chip as the PA. In either case, performance problems caused by radiated field feedback from the PA to the LFO are avoided or substantially reduced.

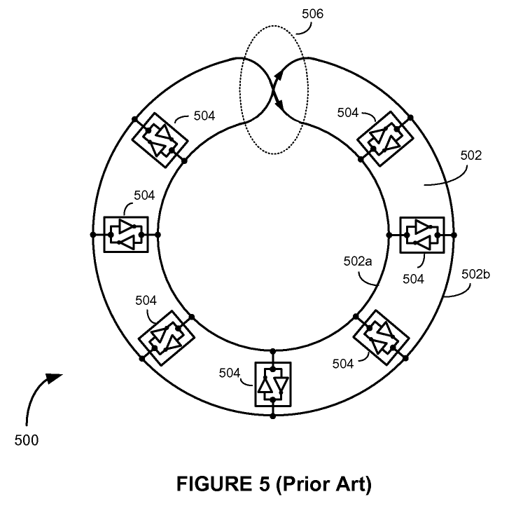

FIG. 5 is a drawing of an LFO 500 known in the art which may be used to implement the LFOs of the RF transmitters 300 and 400 in FIGS. 3 and 4, and which may be used to implement the LFOs of other RF transmitters described below. The LFO 500 comprises a closed-loop transmission line 502, comprised of first and second conjoined conductive loop traces 502a and 502b configured as a planarized differential Moebius strip, and a plurality of bidirectional, regenerative/amplifying circuits 504 distributed between and along the conductive loop traces 502a and 502b. The Moebius-strip-like transmission line 502 is made by forming a half-twist 506 along the length of an open-ended strip and then joining the ends of the strip to form a closed loop. In effect, the half-twist 506 converts the two-dimensional strip, with its two opposing surfaces and two opposing edges, into a strip having only a single surface and a single edge. The field distribution along the Moebius-strip-like transmission line 502 is significantly constrained compared with conventional coiled or spiraled inductor VCOs used in prior art systems, like the one shown in FIG. 1 above. Further details of LFOs similar to that shown and described in FIG. 5 are described in U.S. Pat. No. 6,525,618 to Wood, which is hereby incorporated into this disclosure by reference.

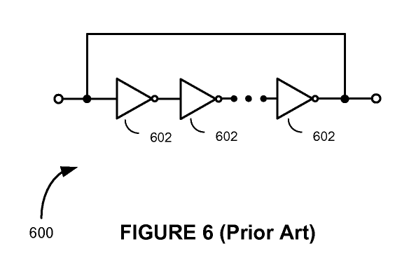

FIG. 6 is a drawing of another type of LFO 600, known as a “ring oscillator,” which can be alternatively used to implement the LFOs of the various embodiments of the present invention. The ring oscillator 600 is generally comprised of an odd number of inverters 602 connected in series, with the output of the last inverter being fed back to the input of the first inverter. The feedback of the output of the last inverter to the input of the first inverter causes oscillation. Similar to the LFO 500 in FIG. 5, the LFO 600 in FIG. 6 generates an electromagnetic field that is substantially lower in strength and more spatially contained than the electromagnetic fields radiated by conventional VCO structures. For these reasons, the LFO 600 can be formed in the same integrated circuit chip as the PA, without the radio system suffering from performance problems as would be observed in a radio system having a PA co-located with a conventional VCO. Further details of the LFO 600, and other types of controlled oscillators that may be used to implement the LFOs in the various embodiments of the present invention, are described in U.S. Pat. No. 6,686,806 to Dufour, which is hereby incorporated into this disclosure by reference.

While two exemplary types of LFOs have been described for use in the various embodiments of the present invention, those of ordinary skill in the art will readily appreciate and understand that other types of low-field oscillators that are inherently less susceptible to radiated field feedback may also be used.

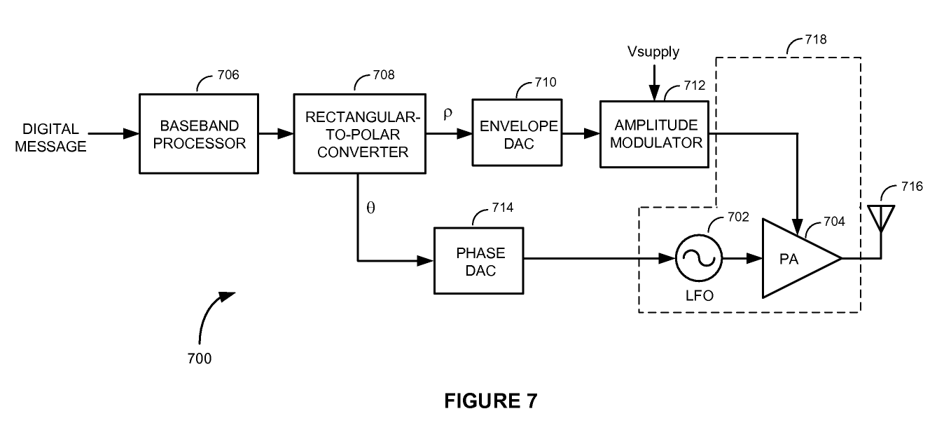

Those of ordinary skill in the art will also appreciate and understand that the co-located LFO and PA aspect of the present invention is not restricted for use in any particular type of RF transmitter. FIG. 7 illustrates, for example, how a co-located LFO 702 and PA 704 may be employed in a polar transmitter 700, in accordance with an embodiment of the present invention. The polar transmitter 700 comprises a baseband processor 706; a rectangular-to-polar converter 708; an envelope digital-to-analog converter (DAC) 710 and amplitude modulator 712 configured within an amplitude path; a phase DAC 714 and LFO 702 configured within a phase path; a PA 704; and an antenna 716. The LFO 702 and PA 704 are co-located on a common RF module 718 or are formed in same integrated circuit chip, similar to the previously described embodiments of the invention.

During operation, the rectangular-to-polar converter 708 converts I and Q baseband signals from the baseband processor 706 into two separate signals—an envelope component signal containing amplitude information of the baseband signal and a phase component signal containing phase information of the baseband signal. The envelope component signal is coupled to the envelope DAC 710, which converts the digital envelope component signal into an analog signal. The analog envelope component signal is then coupled to the amplitude modulator 712, which operates to modulate a power supply source (Vsupply) according to the analog envelope component signal. As the amplitude of the analog envelope component signal changes, the power applied to the power setting input port of the PA 704 changes.

In the phase path, the phase DAC 714 operates to convert the digital phase component signal from the rectangular-to-polar converter 708 into a constant-amplitude analog phase component signal, which is coupled to an input of the LFO 702. The LFO 702 generates an RF phase modulated signal according to the analog phase component signal and couples the resulting RF phase modulated signal to an RF input (e.g., gate or base) of the PA 704. The PA 704 is typically configured so that it is driven into heavy compression, acting in a switch-mode configuration while the modulated power supply signal from the amplitude modulator 712 is coupled to the drain (or collector) of the PA 704. When configured in this manner, the output power of the PA 704 is proportional to the amplitude of the amplitude modulated power supply signal.

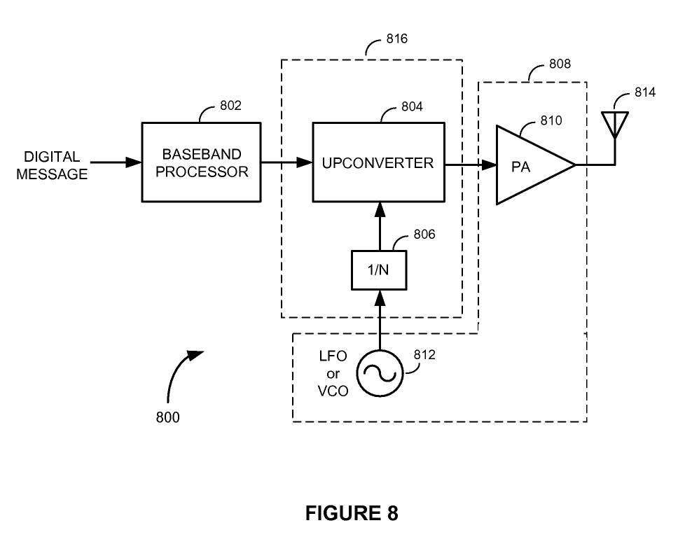

FIG. 8 is a block diagram of an RF transmitter 800, according to another embodiment of the present invention. The RF transmitter 800 comprises a baseband processor 802, an upconverter 804, an integer frequency divider 806, an RF module 808 containing a PA 810 and LFO or VCO 812, and an antenna 814. The RF transmitter 800 operates similar to the embodiment shown and described above in FIG. 3, except that, rather than relying exclusively on an LFO to avoid radiated field feedback, the LFO or VCO 812 is configured to operate at a harmonic of the final desired carrier frequency (i.e., at a harmonic of the frequency of the RF signal at the output of the PA 810). Operating the LFO or VCO 812 at a harmonic of the PA output frequency has the effect of substantially diminishing radiated field feedback that could develop between the oscillator 812 and co-located PA 810. The integer frequency divider 806 is used to divide the frequency output of the LFO or VCO 812 down to the desired RF carrier frequency. It may be formed in the same integrated circuit 816 as the upconverter 804 (as shown in FIG. 8), on the same module 808 as are mounted the PA 810 and LFO or VCO 812, or elsewhere.

Some radiated field feedback of harmonics of the PA output frequency may be observed using the harmonic divider approach in FIG. 8. However, because the amplitudes of any harmonics appearing at the output of the PA 810 are substantially lower in amplitude compared to signals at the intended output frequency of the PA 810, the degree of disruption of the LFO or VCO electromagnetic field is not as pronounced as it would be if the LFO or VCO 812 was configured to operate at the same output frequency as the PA 810.

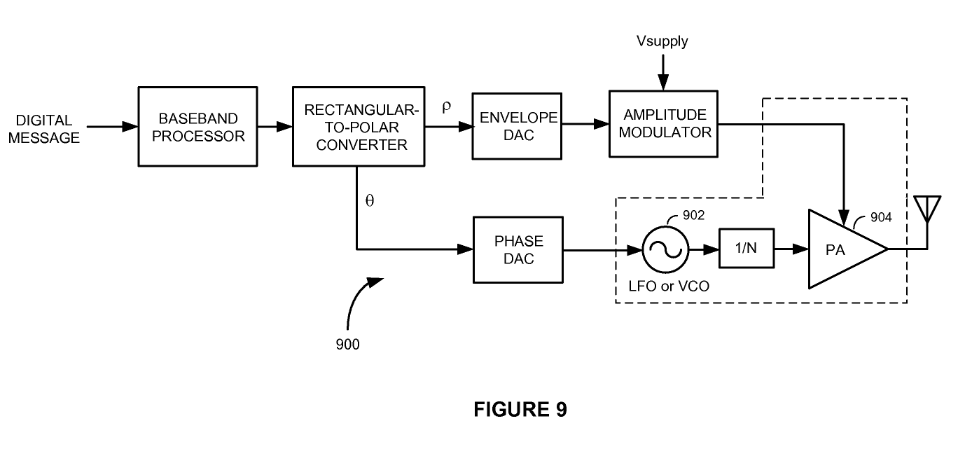

Similar to the various embodiments of the invention described above, the LFO or VCO 812 may be co-located with the PA 810, although co-location is not required in this particular embodiment. Additionally, the aspect of the invention of operating the LFO or VCO 812 at a harmonic of the PA output frequency is not limited to any particular RF transmitter type. FIG. 9 illustrates, for example, how a co-located LFO or VCO 902 and PA 904, and operating the LFO or VCO 902 at a harmonic of the PA output frequency, may be employed in a polar transmitter 900.

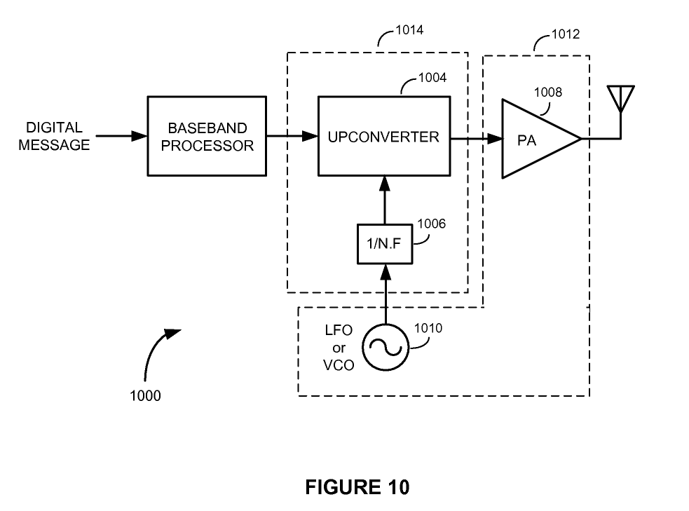

According to another embodiment of the invention shown in FIG. 10, an LFO or VCO 1010 of an RF transmitter 1000 is configured to operate at some rational (i.e., non-integer) multiple of the desired PA output frequency. A fractional divider 1006 is used to divide the frequency output of the LFO or VCO 1010 down to the desired RF carrier frequency. The fractional divider 1006 may be formed in the same integrated circuit 1014 as the upconverter 1004 (as shown in FIG. 10), on the same module 1012 or integrated circuit as the PA 1008 and LFO or VCO 1010, or elsewhere. Operating the LFO or VCO 1010 at a non-integer multiple of the PA output frequency has the effect of substantially diminishing radiated field feedback of both harmonic and non-harmonic signals, which could otherwise develop between the LFO or VCO 1010 and PA 1008.

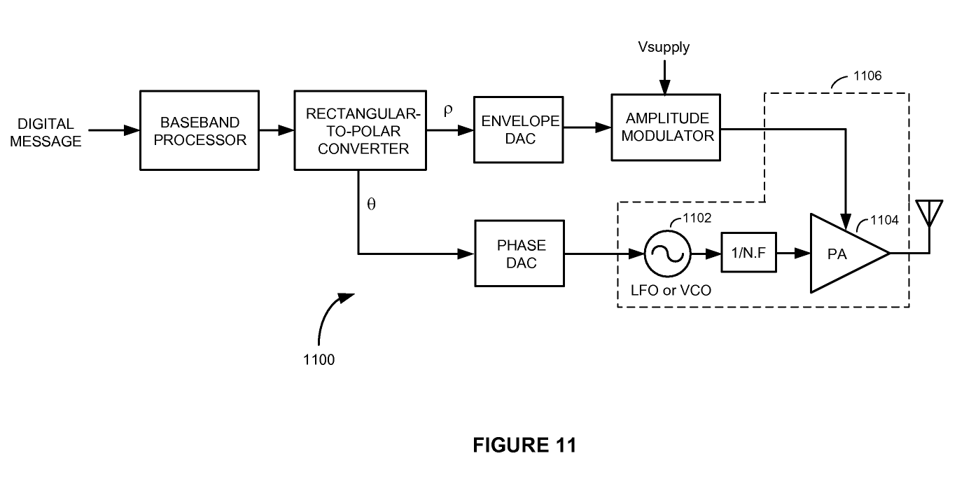

Similar to the other embodiments of the invention described above, operating the LFO or VCO 1010 at a non-integer multiple of the PA output frequency to reduce the effects of radiated field feedback is not limited to any particular RF transmitter type. FIG. 11 illustrates, for example, how an LFO 1102 and PA 1104 and means for operating the LFO or VCO 1102 at a non-integer multiple of the PA output frequency, may be configured on a common RF module 1106 and employed in a polar transmitter 1100.

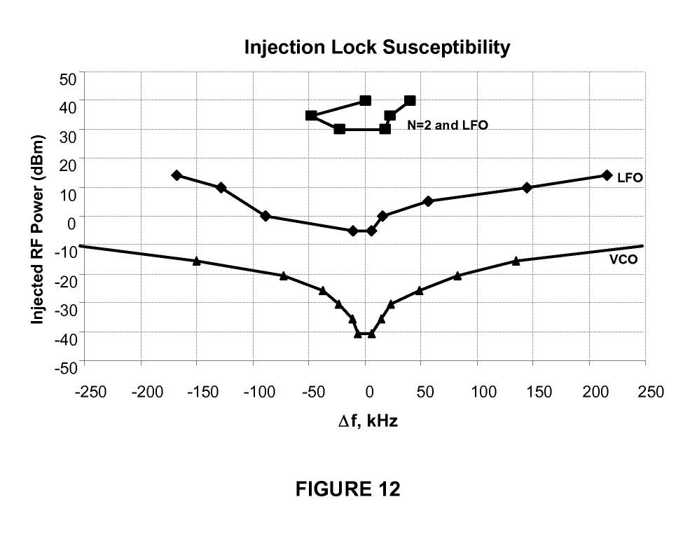

FIG. 12 is a graph comparing the injection lock susceptibilities of RF transmitters having a co-located VCO and PA (as in the prior art), having a co-located LFO and PA, and having a co-located LFO and PA in which the LFO is configured to operate at the second harmonic of the PA output frequency. The data is for measurements taken over a frequency range of 500 kHz centered around a normalized center frequency of 0 kHz, and in response to injected RF fields having power levels that are at or above the power levels that would be generated by the PA and antenna of a transmitter adapted for use in a cellular communications system (e.g., the Global System for Mobile Communications (GSM) system). The curve labeled “VCO” in FIG. 12 is a baseline measurement illustrating just how sensitive a VCO is to radiated field feedback, when the VCO is co-located with the PA. As can be seen, the VCO is susceptible to directly locking to the externally applied field when only −40 dBm of external power is radiated into the VCO. This ultra-sensitivity to very small levels of field feedback highlights why conventional VCOs cannot be co-located with the PA in prior art RF transmitters.

The curve labeled “LFO” in FIG. 12 is a measurement of how sensitive the LFO used in the various embodiments of the present invention described above is to field feedback, when the LFO is co-located with the PA. In this case, the LFO is susceptible to locking to the externally applied field when the power radiated into the LFO is raised to about −5 dBm. Comparing the VCO curve to the LFO curve at the normalized center frequency of 0 kHz reveals that the LFO is over three orders of magnitude less sensitive to radiated field feedback than is the conventional VCO.

Finally, the curve labeled “N=2 and LFO” in FIG. 12 is a measurement of how sensitive the LFO used in the various embodiments of the present invention is to radiated field feedback when the LFO is both co-located with the PA and is configured to operate at a harmonic (the second harmonic, in this case) of the PA output frequency. As can be seen, the LFO is only susceptible to locking to the externally applied field when the power radiated into the LFO is at or above approximately +30 dBm. This combination of co-located LFO and PA and harmonic LFO operation is seven orders of magnitude less sensitive than a co-located VCO and PA.

Although the present invention has been described with reference to specific embodiments thereof, these embodiments are merely illustrative, and not restrictive, of the present invention. For example, while the methods and apparatus described above are particularly useful when adapted for use in cellular handsets configured for operation in a cellular communications network, they can be used in any other wireless communications application in which radiated field feedback may present a problem to predefined operational characteristics such as those defined by wireless communications standards, for example. Various modifications or changes to the specifically disclosed exemplary embodiments will be suggested to persons skilled in the art and are to be included within the spirit and purview of the appended claims.

What is claimed is:

1. A radio frequency (RF) transmitter, comprising:
a baseband processor;
an upconverter circuit coupled to said baseband processor; and
a co-located power amplifier (PA) and low-field oscillator (LFO) coupled to said upconverter circuit.

2. The RF transmitter of claim 1 wherein said LFO comprises:
a transmission line formed in a closed loop; and
a plurality of regenerative/amplifying elements distributed along said transmission line.

3. The RF transmitter of claim 1 wherein said LFO comprises a ring oscillator.

4. The RF transmitter of claim 1 wherein the co-located PA and LFO are formed on a common RF module.

5. The RF transmitter of claim 1 wherein the co-located PA and LFO are formed on a common integrated circuit chip.

6. The RF transmitter of claim 1, further comprising a frequency divider configured within a signal path between an output of said LFO and an input of said PA.

7. The RF transmitter of claim 1 wherein said RF transmitter is adapted for use in a cellular handset configured for operation in a cellular communications system.

8. A radio frequency (RF) transmitter for a radio system, comprising:
means for generating an RF signal;
means for upconverting a baseband signal to RF using said RF signal; and
means for amplifying and radiating an upconverted signal provided by said means for upconverting,
wherein said means for generating an RF signal includes means for reducing radiated field feedback of RF fields radiated from said means for amplifying and radiating to said means for generating an RF signal.

9. The RF transmitter of claim 8 wherein a frequency of said RF signal generated by said means for generating an RF signal is a harmonic of a frequency of said upconverted signal, and said means for reducing radiated field feedback includes an integer frequency divider.

10. The RF transmitter of claim 8 wherein a frequency of said RF signal generated by said means for generating an RF signal is a non-integer multiple of a frequency of said upconverted signal, and said means for reducing radiated field feedback includes a fractional frequency divider.

11. The RF transmitter of claim 8 wherein said means for generating an RF signal comprises a voltage controlled oscillator (VCO).

12. The RF transmitter of claim 8 wherein said means for generating an RF signal comprises a low-field oscillator (LFO).

13. The RF transmitter of claim 8 wherein said means for generating an RF signal and a power amplifier of said means for amplifying and radiating the upconverted signal are co-located on a common RF module.

14. The RF transmitter of claim 8 wherein said means for generating an RF signal and a power amplifier of said means for amplifying and radiating the upconverted signal are co-located in a common integrated circuit chip.

15. A polar transmitter, comprising:
an amplitude modulator configured within an amplitude path operable to modulate a power supply signal according to an amplitude component of a communications signal to generate an amplitude modulated power supply signal;
a low-field oscillator (LFO) configured within a phase path operable to generate a radio frequency (RF) phase modulated signal according to a phase component of said communications signal;
a power amplifier (PA) having a power setting input port configured to receive the amplitude modulated power supply signal from the amplitude modulator and an RF input port configured to receive the RF phase modulated signal from the LFO; and
a module onto which said PA and said LFO are mounted and co-located.

16. The polar transmitter of claim 15 wherein said LFO comprises:
a transmission line formed in a closed loop; and
a plurality of regenerative/amplifying elements distributed along said transmission line.

17. The polar transmitter of claim 15 wherein said LFO comprises a ring oscillator.

18. A polar transmitter, comprising:
an amplitude modulator configured within an amplitude path operable to modulate a power supply signal according to an amplitude component of a communications signal to generate an amplitude modulated power supply signal;
an oscillator configured within a phase path operable to generate a radio frequency (RF) phase modulated signal according to a phase component of said communications signal;
a frequency divider configured to receive said RF phase modulated signal and provide a divided frequency RF phase modulated signal; and
a power amplifier (PA) having a power setting input port configured to receive the amplitude modulated power supply signal from the amplitude modulator and an RF input port configured to receive the divided frequency RF phase modulated signal.

19. The polar transmitter of claim 18 wherein said oscillator comprises a voltage controlled oscillator (VCO).

20. The polar transmitter of claim 18 wherein said oscillator comprises a low-field oscillator (LFO).

21. The polar transmitter of claim 18, further comprising an RF module upon which both said oscillator and said PA are mounted.

22. A method of reducing radiated field feedback in a radio frequency (RF) transmitter, comprising:
generating an RF signal using a low-field oscillator (LFO);
modulating said RF signal with information to be transmitted, to generate a modulated RF signal;
amplifying said modulated RF signal to generate an amplified and modulated RF signal; and
transmitting the amplified and modulated RF signal.

23. The method of claim 22, further comprising frequency dividing the RF signal prior to amplifying it.

24. The method of claim 22 wherein said LFO and an amplifier used to amplify said modulated RF signal are mounted on a common RF module.

25. The method of claim 24 wherein said LFO and the amplifier used to amplify said modulated RF signal are formed in the same integrated circuit chip.
